(19) United States
(12) Patent Application Publication
(10) Pub. No.: US 2009/0305737 A1
(43) Pub. Date: Dec. 10, 2009

(54) DUAL STANDBY MOBILE DEVICE AND COMMUNICATION METHOD THEREOF

(75) Inventors: Gun Woo Bae, Daegu Metropolitan City (KR); Chang Taek Kang, Gumi-si (KR)

Correspondence Address: Jefferson IP Law, LLP, 1130 Connecticut Ave., NW, Suite 420, Washington, DC, 20036, US

(73) Assignee: SAMSUNG ELECTRONICS CO. LTD., Suwon-si (KR)

(21) Appl. No.: 12/480,359

(22) Filed: Jun. 8, 2009

(30) Foreign Application Priority Data
Jun. 9, 2008 (KR) 10-2008-0053526

(51) Int. Cl. H04M 1/00

(52) U.S. Cl. 455/552.1

(57) ABSTRACT

A dual standby mobile device which allows access to at least two different types of communication networks and a communication method thereof are provided. The communication method includes performing a call with another mobile device by driving a first SIM, determining a reason for a call disconnection when the call is disconnected, performing a changeover to a second SIM when an unexpected error is the reason for the call disconnection, and reconnecting the call with the other mobile device by driving the second SIM.

### PRIORITY

This application claims the benefit under 35 U.S.C. § 119(a) of a Korean patent application filed in the Korean Intellectual Property Office on Jun. 9, 2008 and assigned Serial No. 10-2008-0053526, the entire disclosure of which is hereby incorporated by reference.

### BACKGROUND OF THE INVENTION

1. Field of the Invention

The present invention relates to a dual standby mobile device technology. More particularly, the present invention relates to a dual standby mobile device and a communication method thereof that allows a call reconnection through a second Subscriber Identify Module (SIM) when a call using a first SIM is disconnected.

2. Description of the Related Art

With an increased global supply and use of mobile devices, the number of new and advanced mobile devices has been continuously developed to provide a variety of useful functions. A recently launched device is a multi-mode mobile device that uses two or more different communication networks.

A traditional mobile device, such as a single-mode device, is limited in use to service areas of a single type of communication network. However, a multi-mode mobile device is available for use in at least two different types of communication networks. For example, a dual mode mobile device is available for use in both a Code Division Multiple Access (CDMA) network and a Global System for Mobile communication (GSM) network.

However, a dual mode mobile device may have some drawbacks. For example, a dual mode mobile device requires a switchover between different types of communication networks. The switchover is performed by a user's manipulation of menus after booting of the mobile device and after accessing an idle mode. Therefore, a network switchover in the dual mode mobile device is complicated and requires time to perform the network switchover.

A dual standby mobile device has been introduced to address this convenience in the network switchover. Contrary to a dual mode mobile device, a dual standby mobile device can simultaneously support both a CDMA network and a GSM network. Specifically, a dual standby mobile device periodically requests and receives, even in an idle mode, preamble and/or pilot channel signals to and from each base station in a CDMA network and a GSM network. Thereby a channel state such as a Received Signal Strength Indication (RSSI) and a Carrier to Interference and Noise Ratio (CINR) is measured. Accordingly, a dual standby mobile device can support two different types of communication networks.

However, a call using a dual standby mobile device may sometimes be disconnected regardless of a user's intention. Specifically, when a mobile device enters a low power area or when prepaid calling time has been exhausted in a prepaid SIM used for a call, a call may be unexpectedly disconnected.

Therefore, a need exists for a dual standby mobile device and communication method thereof for reconnecting a call after an unexpected disconnection.

### SUMMARY OF THE INVENTION

An aspect of the present invention is to address at least the above-mentioned problems and/or disadvantages and to provide at least the advantages described below. Accordingly, an aspect of the present invention is to provide a dual standby mobile device and a communication method thereof which allows a call reconnection when a call is disconnected due to unexpected errors, such as a low power area entry or an exhaustion of remaining prepaid calling time in a SIM.

Another aspect of the present invention is to provide a dual standby mobile device and a communication method thereof which are capable of a changeover between a first Subscriber Identify Module (SIM) and a second SIM when a call disconnects unexpectedly.

According to an aspect of the present invention, a communication method of a dual standby mobile device which allows access to at least two different types of communication networks is provided. This communication method includes performing a call with another mobile device by driving a first SIM, determining a reason for a call disconnection when the call is disconnected, performing a changeover to a second SIM when an unexpected error is the reason for the call disconnection, and reconnecting the call with the other mobile device by driving the second SIM.

According to another aspect of the present invention, a dual standby mobile device is provided. The device includes a first SIM and a second SIM for allowing access to at least two different types of communication networks, a first communication unit for accessing a first communication network of the at least two types of communication networks through the first SIM driven to perform a call with another mobile device, a second communication unit for accessing a second communication network of the at least two types of communication networks through the second SIM driven to perform the call with the other mobile device, and a control unit for determining a reason for a call disconnection when the call is disconnected, for performing a changeover to the second SIM when an unexpected error is the reason for the call disconnection, and for reconnecting the call with the other mobile device by driving the second SIM.

Other aspects, advantages and salient features of the invention will become apparent to those skilled in the art from the following detailed description, which, taken in conjunction with the annexed drawings, discloses exemplary embodiments of the invention.

### BRIEF DESCRIPTION OF THE DRAWINGS

The above and other aspects, features and advantages of certain exemplary embodiments of the present invention will be more apparent from the following description taken in conjunction with the accompanying drawings, in which:

FIG. 1A is a schematic view illustrating a communication system including a dual standby mobile device according to an exemplary embodiment of the present invention.

FIG. 1B is a block diagram illustrating a dual standby mobile device according to an exemplary embodiment of the present invention.

FIG. 2 is a flow diagram illustrating a communication method of a dual standby mobile device according to an exemplary embodiment of the present invention.

FIG. 3 is a flow diagram illustrating a process for determining a reason for a call disconnection according to an exemplary embodiment of the present invention.

FIG. 4 is a flow diagram illustrating a communication method between dual standby mobile devices and communication networks according to an exemplary embodiment of the present invention.

FIG. 5 is a flow diagram illustrating a communication method between dual standby mobile devices and communication networks according to an exemplary embodiment of the present invention.

FIG. 6 is a flow diagram illustrating a communication method of a dual standby mobile device according to an exemplary embodiment of the present invention.

FIG. 7 is a flow diagram illustrating a communication method between dual standby mobile devices and communication networks according to an exemplary embodiment of the present invention.

FIG. 8 is a flow diagram illustrating a communication method between dual standby mobile devices and communication networks according to an exemplary embodiment of the present invention.

Throughout the drawings, it should be noted that like reference numbers are used to depict the same or similar elements, features and structures.

### DETAILED DESCRIPTION OF EXEMPLARY EMBODIMENTS

The following description with reference to the accompanying drawings is provided to assist in a comprehensive understanding of exemplary embodiments of the invention as defined by the claims and their equivalents. It includes various specific details to assist in that understanding but these are to be regarded as merely exemplary. Accordingly, those of ordinary skill in the art will recognize that various changes and modifications of the embodiments described herein can be made without departing from the scope and spirit of the invention. In addition, descriptions of well-known functions and constructions are omitted for clarity and conciseness.

The terms and words used in the following description and claims are not limited to the bibliographical meanings, but, are merely used by the inventor to enable a clear and consistent understanding of the invention. Accordingly, it should be apparent to those skilled in the art that the following description of exemplary embodiments of the present invention are provided for illustration purpose only and not for the purpose of limiting the invention as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Exemplary embodiments of the present invention include a dual standby mobile device capable of simultaneously accessing at least two wireless communication networks with different mobile standards or different mobile communication operators. For example, a dual standby mobile device of the exemplary embodiments of the present invention allows simultaneous access to two networks with different mobile standards, such as a Code Division Multiple Access (CDMA), a Global System for Mobile communication (GSM), a Wideband Code Division Multiple Access (WCDMA) and a Wireless Broadband (WiBro), or different mobile operators such as SK Telecom (SKT), Korea Telecom Freetel (KTF) and LG Telecom (LGT) in Korea.

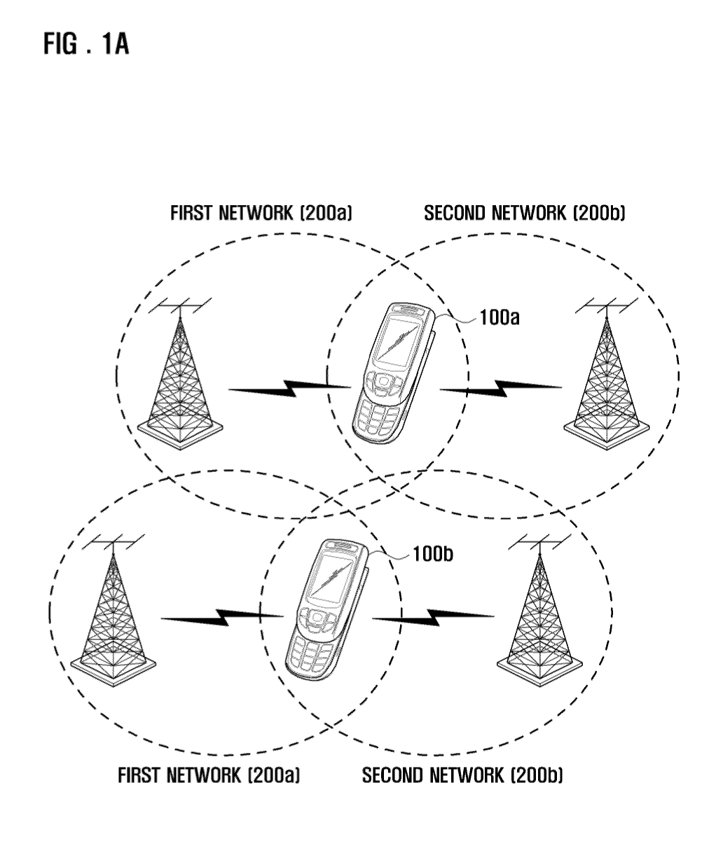

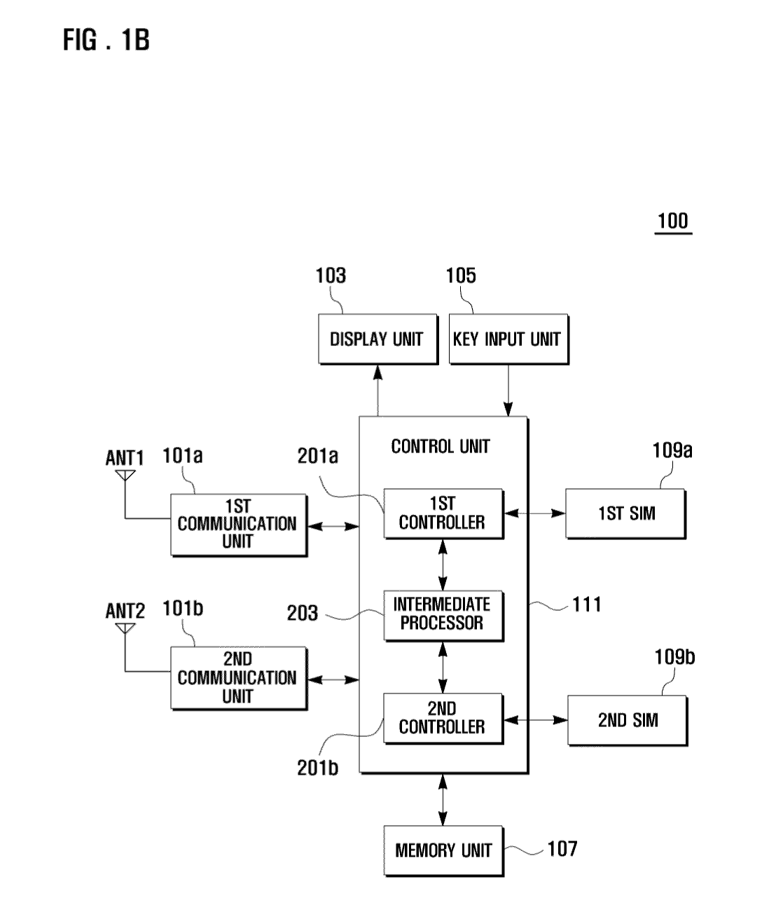

FIG. 1A is a schematic view that illustrates a communication system including a dual standby mobile device according to an exemplary embodiment of the present invention.

Referring to FIG. 1A, the communication system is schematically composed of a plurality of mobile devices 100a and 100b (generically illustrated as mobile device 100 in FIG. 1B), and two different communication networks 200a and 200b. The mobile devices 100a and 100b are dual standby mobile devices, and the two different networks 200a and 200b are based on different mobile standards or different mobile operators. Hereinafter, one of the two different networks will be referred to as a first communication network 200a, and the other network will be referred to as a second communication network 200b. Additionally, one of the mobile devices will be referred to as a first mobile device 100a and is considered a transmitting device. The other mobile device will be referred to as a second mobile device 100b and is considered a receiving device or a destination device.

The mobile devices 100a and 100b are capable of a voice call, a Short Message Service (SMS), a Multimedia Message Service (MMS), an Enhanced Message Service (EMS), and the like. Also, the mobile devices 100a and 100b have the ability to play music through an embedded music player and to take a picture through an embedded camera module.

The mobile devices 100a and 100b may have at least one Subscriber Identify Module (SIM) to access at least two different communication networks. Hereinafter, with the assumption that the first mobile device 100a and the second mobile device 100b each have two SIMs, the first SIM functions as a master SIM, and the second SIM functions as a slave SIM.

The first mobile device 100a drives the first SIM 109a (as illustrated in FIG. 1B) and performs a call with the second mobile device 100b. When a call is disconnected due to an unexpected error, the first mobile device 100a drives the second SIM 109b (as illustrated in FIG. 1B) and reconnects a call with the second mobile device 100b. That is, when a call with the second mobile device 100b in the first communication network 200a is unexpectedly interrupted, the first mobile device 100a accesses the second communication network 200b and reconnects a call with the second mobile device 100b.

FIG. 1B is a block diagram that illustrates a dual standby mobile device according to an exemplary embodiment of the present invention.

Referring to FIGS. 1A and 1B, the mobile device 100 includes a first communication unit 101a, a second communication unit 101b, a display unit 103, a key input unit 105, a memory unit 107, a first SIM 109a, a second SIM 109b and a control unit 111.

The first communication unit 101a and the second communication unit 101b are Radio Frequency (RF) units that execute wireless communication functions. Each of the first communication unit 101a and the second communication unit 101b includes an RF transmitter that up-converts the frequency of transmission signals and amplifies transmission signals, an RF receiver that down-converts the frequency of reception signals and low-noise amplifies reception signals, a duplexer that isolates the receiver from the transmitter and an antenna (ANT1, ANT2).

The first communication unit 101a is configured to access the first communication network 200a, and the second communication unit 101b is configured to access the second communication network 200b. For example, if the first network 200a and the second network 200b are a GSM network and a CDMA network, respectively, each of the first communication unit 101a and the second communication unit 101b performs wireless transmission and reception based on protocols of the corresponding GSM or CDMA network. Similarly, if the first network 200a and the second network 200b are operated by SKT and KTF, respectively, each of the first communication unit 101a and the second communication unit 101b performs wireless transmission and reception based on protocols of the corresponding operator's network.

The display unit 103 displays various graphical information related to the state and operations of the mobile device 100. For example, when a call using the first SIM 109a, i.e., a master SIM, is unexpectedly disconnected, the display unit 103 displays a pop-up window informing a user that the second SIM 109b, i.e., a slave SIM, is driven. The display unit 103 may be formed of a Liquid Crystal Display (LCD), an Organic Light Emitting Diode (OLED), a Plasma Display Panel (PDP) and the like.

The key input unit 105 creates input signals based on user's manipulations for the mobile device 100. For example, the key input unit 105 receives a user's selection of a destination device for an outgoing call, a user's request for an outgoing call and the like, and creates corresponding input signals. The key input unit 105 may be formed of a keypad, a touchpad and the like.

The memory unit 107 stores programs and information required for operation of the mobile device 100. For example, the memory unit 107 stores programs and related data required for access to the first network 200a and the second network 200b through the first communication unit 101a and the second communication unit 101b. Additionally, the memory unit 107 may be composed of a first memory subunit and a second memory subunit which are controlled respectively by a first controller 201a and a second controller 201b that will be described below.

The first SIM 109a and the second SIM 109b are smart cards which allow simultaneous support for a dual standby mode, e.g., a GSM mode and a CDMA mode, or an SKT mode and a KTF mode. If the first SIM 109a and the second SIM 109b are available for a GSM mode and a CDMA mode, respectively, the first SIM 109a and the second SIM 109b each stores data related to the corresponding mode. Data stored in each SIM may include subscriber information, certification information, communication related records and the like.

Data in the first SIM 109a and the second SIM 109b may be managed by a file system composed of a Master File (MF), a Dedicated File (DF) and an Elementary File (EF). The MF corresponds to a root file. The DF, which is a subdirectory of the MF, may be a file corresponding to a mobile operator's service or a service for supporting a function required in the GSM or the CDMA. The DF has a plurality of EFs which store data used in such a service. The EF is a file required for the execution of application files of each DF. The EF stores subscriber information, such as subscriber phone numbers, service charge details or frequently used phone numbers, and certification information related to security.

The first SIM 109a and the second SIM 109b may be inserted in a card connector (not illustrated) used for interface and controlled by the first controller 201a and the second controller 201b, respectively. That is, the first SIM 109a and the second SIM 109b transmit input/output signals through the card connector under the control of the respective first controller 201a and the second controller 201b. The card connector may have slots to and from which the first SIM 109a and the second SIM 109b are inserted and withdrawn. If the mobile device has a single SIM, the card connector may have a single slot.

The control unit 111 provides control signals required for entire operations of the mobile device 100. More particularly, the control unit 111 controls communication functions of the dual standby mobile device 100. For example, if a call is unexpectedly disconnected while using the first SIM, the control unit 111 determines a reason for disconnection. The call disconnection in the mobile device 100 reason may be caused by a low power area entry or an exhaustion of remaining prepaid calling time, if the first SIM is a prepaid SIM, both of which are unexpected cases that may happen regardless of a user's intention. Also, the call disconnection in the mobile device 100 may be caused by an end action input, which may depend on a user's intention.

When a call is disconnected, the control unit 111 reconnects the call with an opposite device, such as the second mobile device 100b by driving the second SIM 109b, i.e., a slave SIM. Here, the control unit 111 may activate an alarm function to inform a user that the second SIM 109b is driven. For example, the alarm function may be the display of a pop-up window, the output of an alarm sound, the generation of a vibration, or the turn-on of a sign lamp.

The control unit 111 includes the first controller 201a, the second controller 201b and an intermediate processor 203. When the first SIM 109a and the second SIM 109b are established respectively for the GSM mode and the CDMA mode, the first controller 201a and the second controller 201b control the GSM mode and the CDMA mode, respectively. Each of the first controller 201a and the second controller 201b may be formed of a micro controller chip for wireless communications, and may have a data processing module including a modem and a codec. The codec may be composed of a data codec for processing packet data and an audio codec for processing audio signals. The first controller 201a and the second controller 201b encode and modulate signals transmitted through the first communication unit 101a and the second communication unit 101b. Also, the first controller 201a and the second controller 201b demodulate and decode signals received through the first communication unit 101a and the second communication unit 101b.

One of the first controller 201a and the second controller 201b may be assigned as a main controller to control all units of the mobile device 100. The first controller 201a and the second controller 201b may be fixedly assigned as the main controller, or may be selectively assigned as the main controller depending on an occurrence of events. For example, the first controller 201a becomes the main controller when a GSM call is incoming, and the second controller 201b becomes the main controller when a CDMA call is incoming.

The intermediate controller 203 functions as an interface for interactions between the first controller 201a and the second controller 201b.

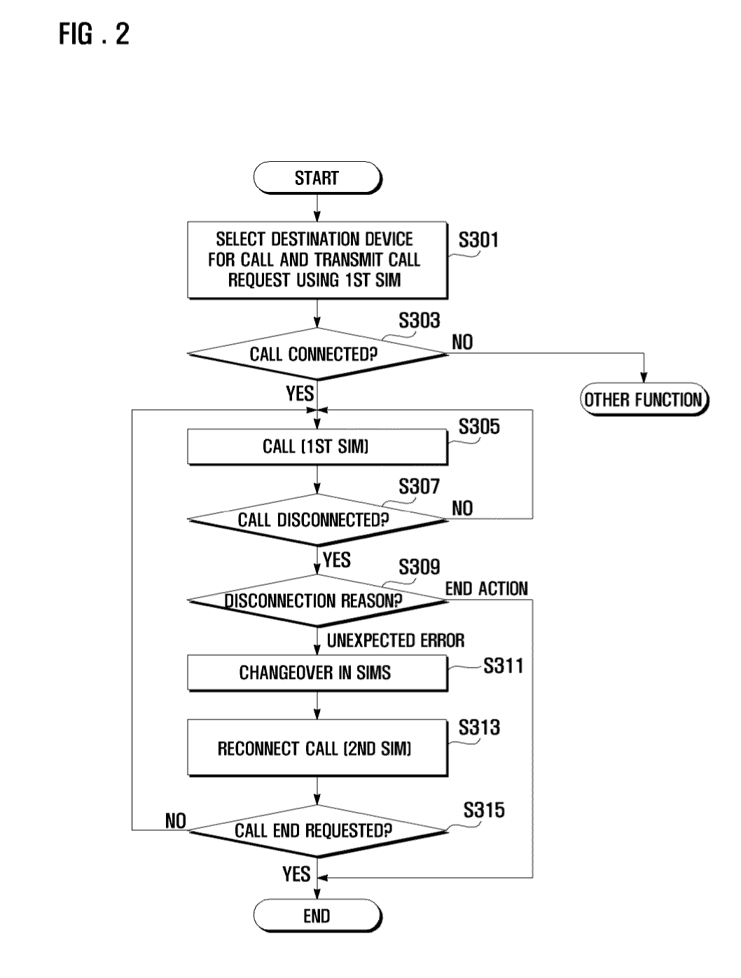

FIG. 2 is a flow diagram that illustrates a communication method of a dual standby mobile device according to an exemplary embodiment of the present invention.

Referring to FIG. 2, along with FIGS. 1A and 1B, the control unit 111 of the first mobile device 100a receives a user's selection of a destination device (i.e., the second mobile device 100b) for an outgoing call through the key input unit 105, and transmits a call request signal to the second mobile device 100b in step S301. Here, the first SIM 109a is driven for a call request. Specifically, the first SIM 109a is predefined as the master SIM of the first mobile device 100a, and the control unit 111 transmits a call request signal to the destination device 100b through the first network 200a by driving the first SIM 109a.

The control unit 111 determines whether a call is connected in step S303. If it is determined that a call is connected, the control unit 111 performs a call with the second mobile device 100b in step S305.

The control unit 111 further determines whether a call is disconnected in step S307. If it is determined that a call is still connected, the control unit 111 returns to step S305 and continues a call with the second mobile device 100b.

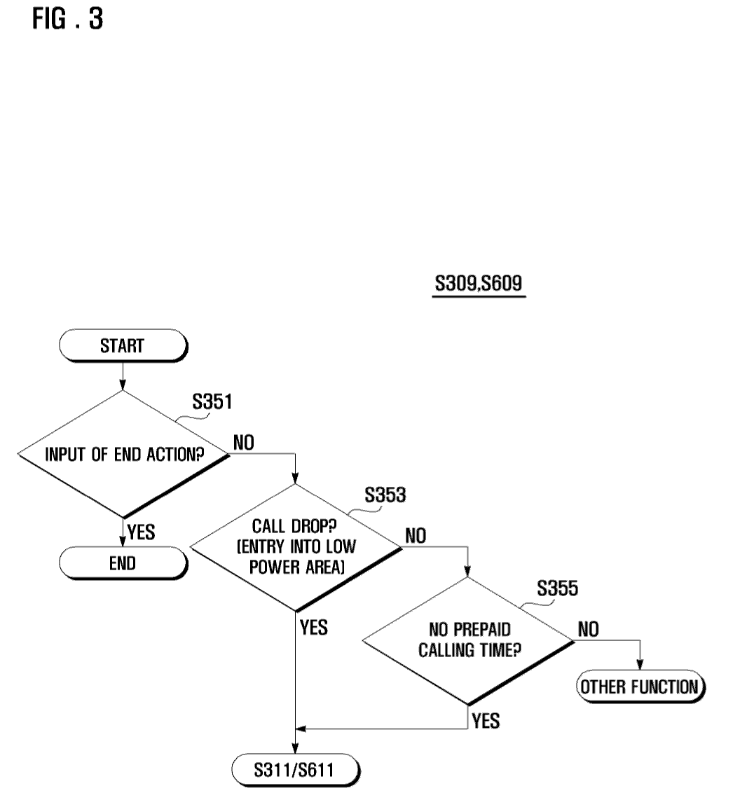

If it is determined that a call is disconnected, the control unit 111 further determines a reason for the call disconnection in step S309. Step S309 is described in more detail with reference to FIG. 3.

FIG. 3 is a flow diagram that illustrates a process for determining a reason for a call disconnection according to an exemplary embodiment of the present invention.

Referring to FIG. 3, the control unit 111 determines whether there is an end action input in step S351. The end action may be performed by a press of an end key, a sliding movement to close a slide-type device case, a folding movement to close a folder-type device case and the like. If any end action is input, the control unit 111 disconnects a call.

If there is no end action, the control unit 111 further determines whether a call drop occurs in step S353. This call drop may be caused by an entry of the mobile device 100a into a low power area. To determine a call drop, the control unit 111 verifies periodically or continuously a field strength in the first network 200a. If the field strength is smaller than a certain value, the control unit 111 recognizes that the mobile device 100a entered a low power area. An entry into a low power area may cause disconnection with the first network 200a. When a call disconnection is due to a call drop, the control unit 111 performs a changeover between the SIMs in step S311 (as illustrated in FIG. 2), which will be described below.

If it is determined in step S353 that a call drop does not occur, the control unit 111 further determines whether any remaining prepaid calling time in the first SIM 109a is exhausted in step S355. Step S355 is performed when the first SIM 109a is a prepaid SIM, which is paid in advance and allows a call time according to an amount of time prepaid. The control unit 111 may verify the remainder of the prepaid calling time. When a call disconnection is due to the remaining prepaid calling time being exhausted, the control unit 111 performs a changeover between the SIMs in step S311, which will be described below.

Returning to FIG. 2, if it is determined in step S309 that a call disconnection is due to an end action input, the control unit 111 disconnects a call.

However, if it is determined in step S309 that any unexpected error (i.e., a call drop or remaining prepaid calling time exhausted) is a reason for a call disconnection, the control unit 111 performs a changeover between the SIMs in step S311. That is, the control unit 111 drives the second SIM 109b instead of the first SIM 109a initially used for a call. At this time, as discussed above, the control unit 111 may display a pop-up window on the display unit 103, output an alarm sound, generate a vibration, or turn on a sign lamp to notify of the changeover between the SIMs.

The control unit 111 then reconnects a call with the second mobile device 100b in step S313. Specifically, by driving the second SIM 109b, the control unit 111 transmits a request for a call with the destination to the second network 200b and thereby reconnects a disconnected call through the second network 200b. When a call is disconnected due to unexpected errors, the control unit 111 may temporarily store information related to the second mobile device 100b in the memory unit 107. Once the changeover between the SIMs immediately occurs, the control unit 111 may reconnect a call by using the stored information related to the destination device 100b. After reconnection, the temporarily stored information may be deleted or maintained.

Next, the control unit 111 determines whether an end of a call is requested in step S315. If a request for ending a call is normally input from the first mobile device 100a or the second mobile device 100b, the control unit 111 disconnects a call. If no request for ending a call is input, the control unit 111 returns to step S305 and continues a call with the second mobile device 100b.

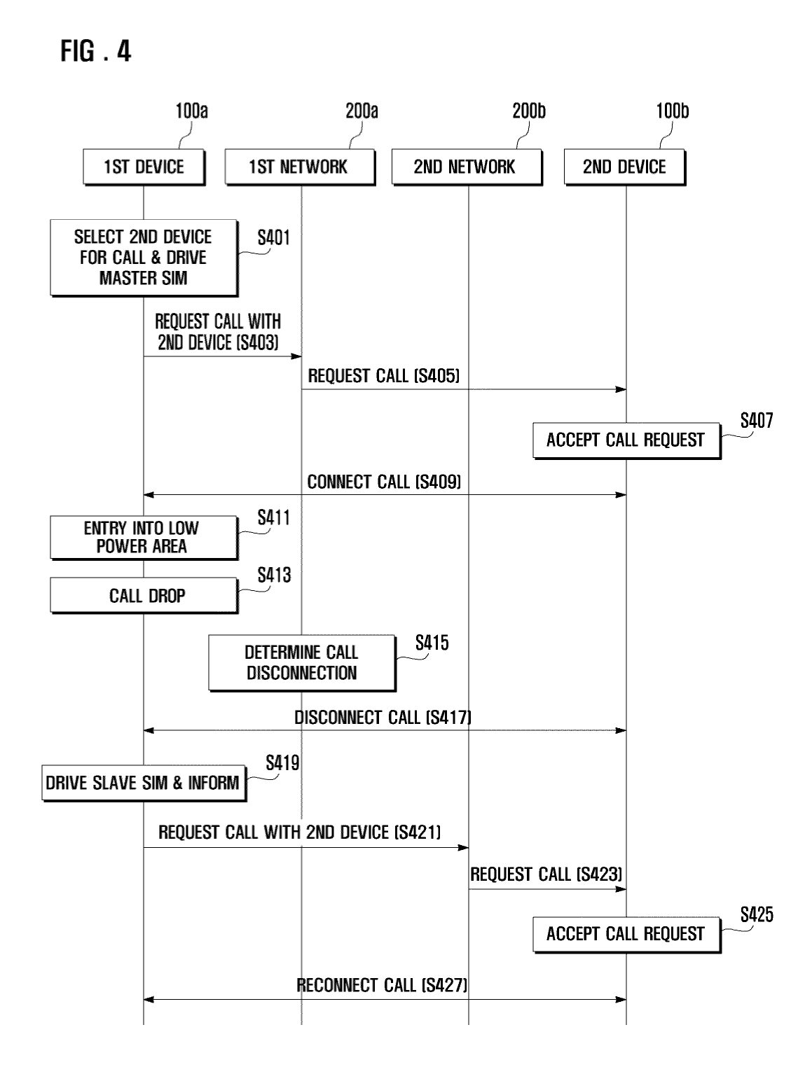

FIG. 4 is a flow diagram that illustrates a communication method between dual standby mobile devices and communication networks according to an exemplary embodiment of the present invention.

Referring to FIG. 4, the first mobile device 100a selects the second mobile device 100b as a destination device for a call and drives the first SIM 109a as the master SIM in step S401.

The first mobile device 100a requests a call with the second mobile device 100b to a call control server of the first network 200a related to the first SIM 109a in step S403. The call control server of the first network transmits a call request of the first mobile device 100a to the second mobile device 100b in step S405.

After receiving the call request, the second mobile device 100b accepts the call request in step S407. Therefore, a call is connected between the first mobile device 100a and the second mobile device 100b in step S409.

The first mobile device 100a recognizes an entry into a low power area in step S411 and therefore determines whether a call drop occurred in the first network 200a in step S413. That is, a connection is interrupted between the first mobile device 100a and the first network 200a.

The call control server of the first network 200a determines a call disconnection between the first mobile device 100a and the second mobile device 100b in step S415. Therefore, a call is disconnected between the first mobile device 100a and the second mobile device 100b in step S417.

The first mobile device 100a drives the second SIM 109b, which is the slave SIM, and also informs a user regarding the changeover between the SIMs by means of a pop-up window, an alarm sound, a vibration, or a sign lamp in step S419.

The first mobile device 100a requests a call with the second mobile device 100b to a call control server of the second network 200b related to the second SIM 109b in step S421. The call control server of the second network then transmits a call request of the first mobile device 100a to the second mobile device 100b in step S423.

After receiving a call request, the second mobile device 100b accepts a call request in step S425. Accordingly, a call is reconnected between the first mobile device 100a and the second mobile device 100b in step S427.

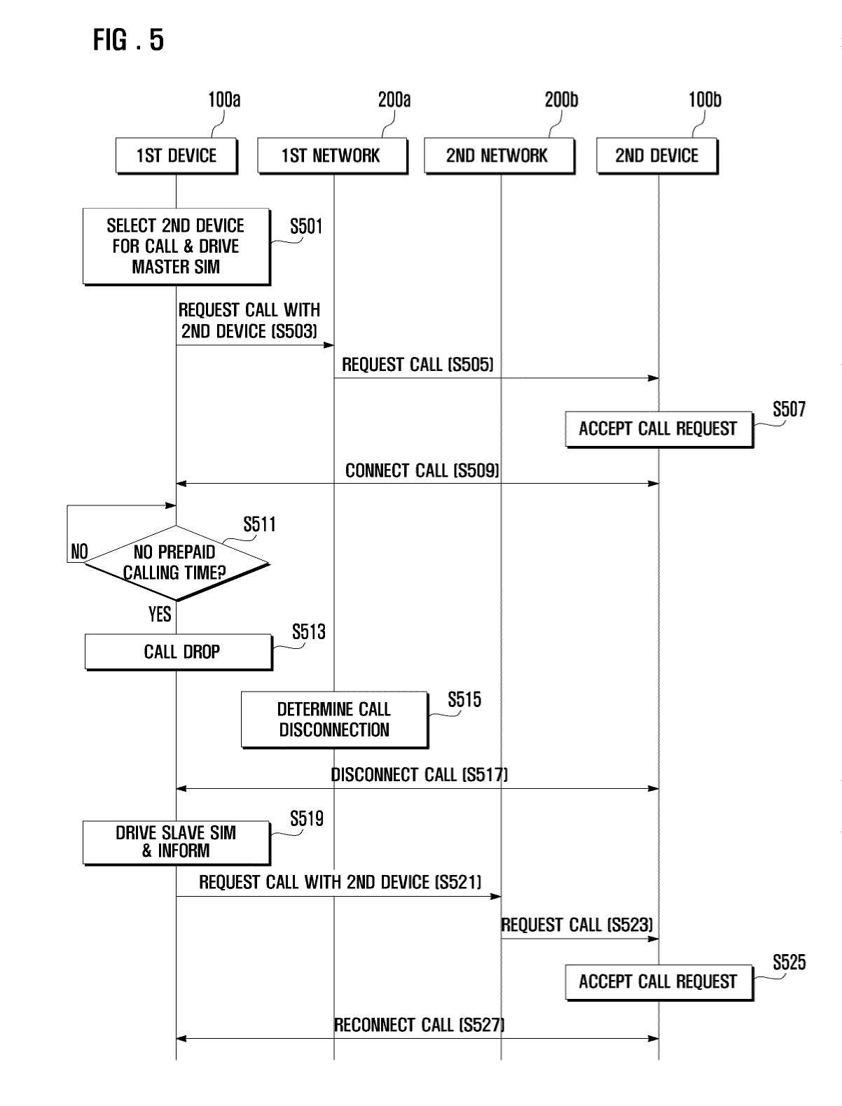

FIG. 5 is a flow diagram that illustrates a communication method between dual standby mobile devices and communication networks according to an exemplary embodiment of the present invention. The communication method in FIG. 5 is similar to the above described communication method in FIG. 4. However, the communication method in FIG. 5 determines a reason for a call disconnection.

Referring to FIG. 5, the first mobile device 100a selects the second mobile device 100b as a destination device for a call and drives the first SIM 109a as the master SIM in step S501.

The first mobile device 100a requests a call with the second mobile device 100b to a call control server of the first network 200a related to the first SIM 109a in step S503. The call control server of the first network transmits a call request of the first mobile device 100a to the second mobile device 100b in step S505.

After receiving the call request, the second mobile device 100b accepts the call request in step S507. Accordingly, a call is connected between the first mobile device 100a and the second mobile device 100b in step S509.

The first mobile device 100a determines whether the prepaid calling time in the first SIM 109a has been exhausted in step S511. If the first SIM 109a is a prepaid SIM, prepaid calling time may be exhausted during a call.

If the first SIM 109a does not have any remaining prepaid calling time, the first mobile device 100a determines that a call drop occurred in the first network 200a in step S513. Thereafter, the call control server of the first network 200a determines a call disconnection between the first mobile device 100a and the second mobile device 100b in step S515. Accordingly, a call is disconnected between the first mobile device 100a and the second mobile device 100b in step S517.

The first mobile device 100a drives the second SIM 109b, which is the slave SIM, and also informs a user regarding the changeover between the SIMs by means of a pop-up window, an alarm sound, a vibration, or a sign lamp in step S519.

The first mobile device 100a requests a call with the second mobile device 100b to a call control server of the second network 200b related to the second SIM 109b in step S521. Then the call control server of the second network transmits a call request of the first mobile device 100a to the second mobile device 100b in step S523.

After receiving the call request, the second mobile device 100b accepts the call request in step S525. Accordingly, a call is reconnected between the first mobile device 100a and the second mobile device 100b in step S527. Additionally, if the second SIM 109b is a prepaid SIM, the first mobile device 100a returns to step S511 and verifies whether prepaid calling time in the second SIM 109b is exhausted during a call.

The communication methods described above, as illustrated in FIGS. 4 and 5, are cases in which the first mobile device (i.e., a transmitting device) enters a low power area or the first mobile device SIM does not have any remaining prepaid calling time. However, exemplary embodiments of the present invention are not limited thereto. The above described communication method may also be applied to similar cases in which the second mobile device (i.e., a receiving device) enters a low power area or the second mobile device SIM exhausts its prepaid calling time.

In the above described communication methods, the reason for a call disconnection is exemplary only and should not be considered as a limitation of the exemplary embodiments of the present invention. The above discussed communication methods may also be applied to cases in which a call is disconnected due to any other unexpected errors.

In the following description of exemplary embodiments, some elements are substantially the same as described above. Therefore, descriptions thereof will be omitted below.

An exemplary embodiment of the present invention determines a reason for an unexpected call disconnection in a receiving mobile device. In this case, a changeover between SIMs is made in the receiving device.

Referring again to FIG. 1A, the first mobile device 100a may be a receiving device, and the second mobile device 100b may be a transmitting device. Therefore, the first device 100a receives a call request from the second device 100b. During a call, unexpected errors of the receiving device 100a may cause a call disconnection and the receiving device 100a reconnects a call by driving the second SIM 109b instead of the first SIM 109a.

Referring again to FIG. 1B, the control unit 111 of the first mobile device 100a determines a reason for the call disconnection when the call with the second mobile device 100b is unexpectedly disconnected. The disconnection reason may be that the first mobile device 100a enters into a low power area or exhausts a prepaid calling time in the first SIM 109a of the receiving device 100a, both of which are unexpected cases that may happen regardless of the user's intention. Also, the disconnection reason may be an end action input in the receiving device 100a, which depends on a user's intention.

When a call is disconnected, regardless of a user's intention, the control unit 111 of the first mobile device 100a reconnects a call with the second mobile device 100b by driving the second SIM 109b instead of the first SIM 109a.

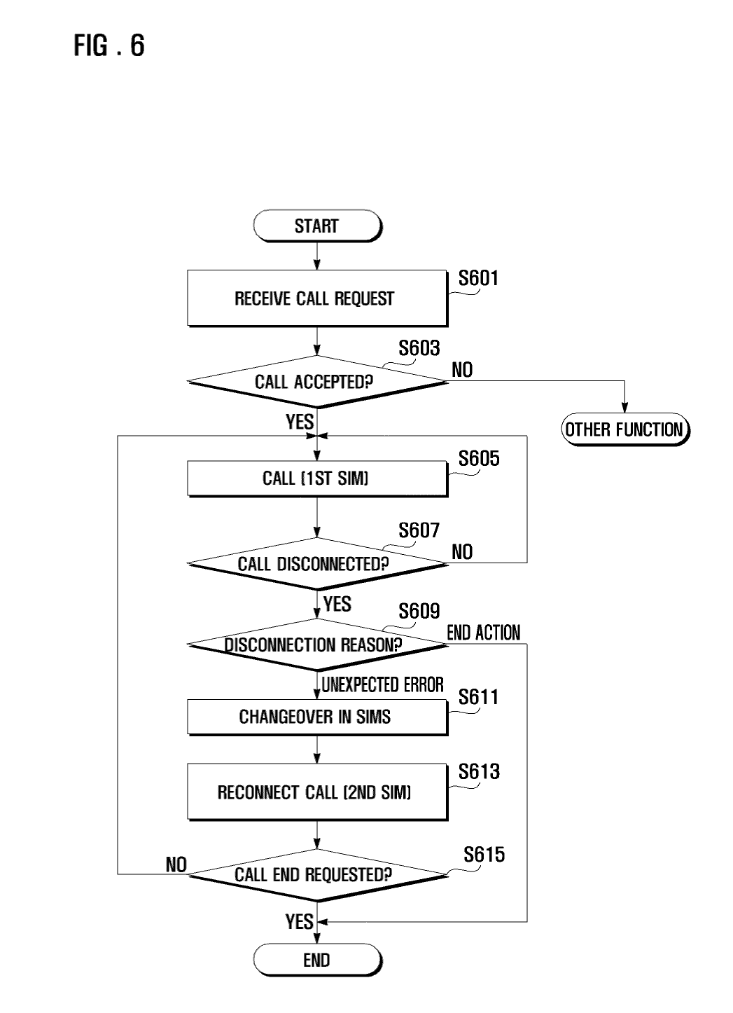

FIG. 6 is a flow diagram that illustrates a communication method of a dual standby mobile device according to an exemplary embodiment of the present invention.

Referring to FIG. 6, together with FIGS. 1A and 1B, the control unit 111 of the first mobile device 100a receives a call request from the second mobile device 100b in step S601.

The control unit 111 determines whether to accept the call request in step S603. If the call request is accepted, the control unit 111 performs a call with the second mobile device 100b in step S605. Here, a SIM assigned for a call may depend on the master SIM of the second mobile device 100b. That is, if the second mobile device 100b (i.e., the transmitting device) drives the first SIM 109a as the master SIM and transmits a call request through the first network 200a, the first mobile device 100a (i.e., the receiving device) also drives the first SIM 109a and performs a call through the first network 200a. However, if the second mobile device 100b drives the second SIM 109b, the first mobile device 100a uses the second SIM 109b for a call through the second network 200b.

The control unit 111 further determines whether a call is disconnected in step S607. If it is determined that a call is still connected, the control unit 111 returns to step S605 and continues a call with the second mobile device 100b.

If it is determined that a call is disconnected, the control unit 111 further determines a reason for the call disconnection in step S609. Step S609 is illustrated in FIG. 3 and described above.

Referring to FIG. 3, if it is determined that an end action is input in step S351, the control unit 111 disconnects a call.

If there is no end action, that is, if a call disconnection is due to a call drop in step S353 or the prepaid calling time in the SIM has been exhausted in step S355, the control unit 111 performs a changeover between the SIMs in step S611. That is, the control unit 111 drives the second SIM 109b instead of the first SIM 109a initially used for a call. At this time, the control unit 111 may display a pop-up window on the display unit 103, output an alarm sound, generate a vibration, or turn on a sign lamp to notify of the changeover between SIMs.

Returning to FIG. 6, after a changeover between the SIMs, the control unit 111 reconnects a call with the second mobile device 100b in step S613. The control unit 111 determines whether a call end requested in step S615. If no request for ending a call is input, the control unit 111 returns to step S605 and continues a call.

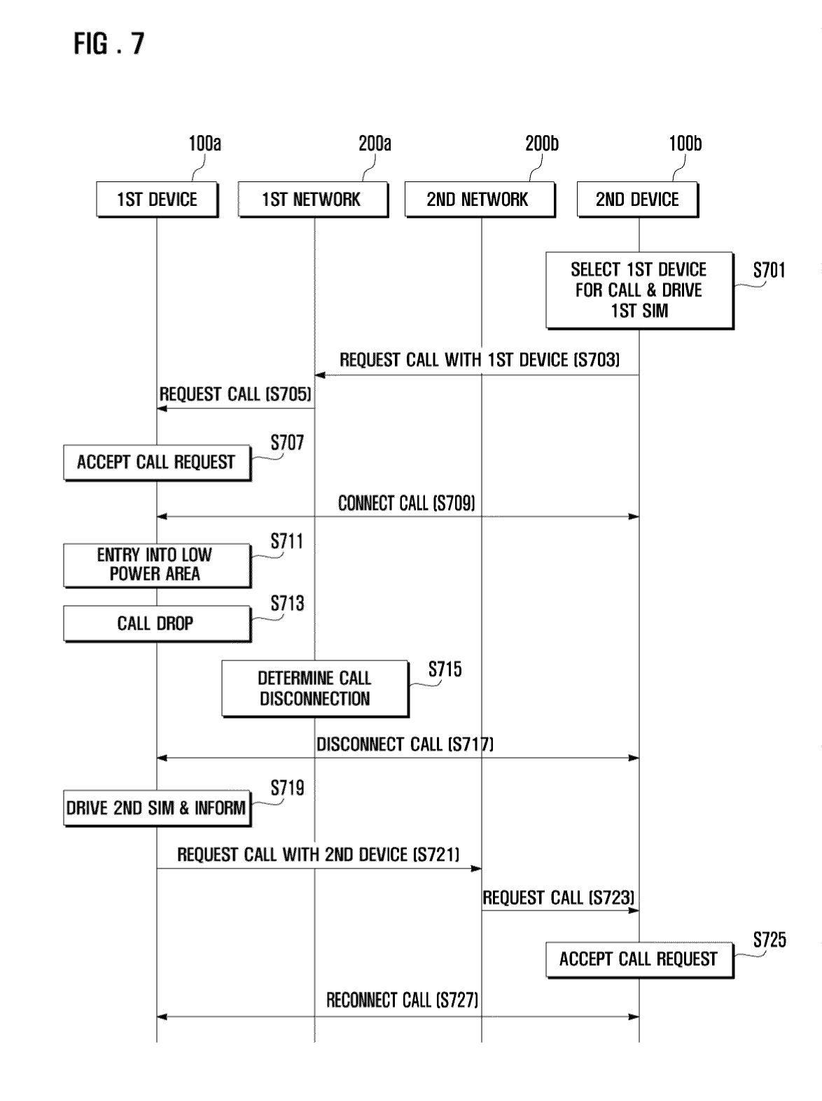

FIG. 7 is a flow diagram that illustrates a communication method between dual standby mobile devices and communication networks according to an exemplary embodiment of the present invention.

Referring to FIG. 7, the second mobile device 100b selects the first mobile device 100b as a destination device for a call and drives the first SIM 109a as the master SIM in step S701.

The second mobile device 100b requests a call with the first mobile device 100a to a call control server of the first network 200a related to the first SIM 109a in step S703. The call control server of the first network transmits a call request of the second mobile device 100b to the first mobile device 100a in step S705.

After receiving the call request, the first mobile device 100a accepts the call request in step S707. Accordingly, a call is connected between the first mobile device 100a and the second mobile device 100b in step S709.

Next, the first mobile device 100a recognizes an entry into a low power area in step S711 and determines that a call drop occurred in the first network 200a in step S713. That is, a connection is interrupted between the first mobile device 100a and the first network 200a.

The call control server of the first network 200a determines a call disconnection between the first mobile device 100a and the second mobile device 100b in step S715. Therefore, a call is disconnected between the first mobile device 100a and the second mobile device 100b in step S717.

Next, the first mobile device 100a drives the second SIM 109b and informs a user regarding the changeover between the SIMs by means of a pop-up window, an alarm sound, a vibration, or a sign lamp in step S719.

Next, the first mobile device 100a requests a call with the second mobile device 100b to a call control server of the second network 200b related to the second SIM 109b in step S721. The call control server of the second network transmits a call request of the first mobile device 100a to the second mobile device 100b in step S723.

After receiving the call request, the second mobile device 100b accepts the call request in step S725. Accordingly, a call is reconnected between the first mobile device 100a and the second mobile device 100b in step S727.

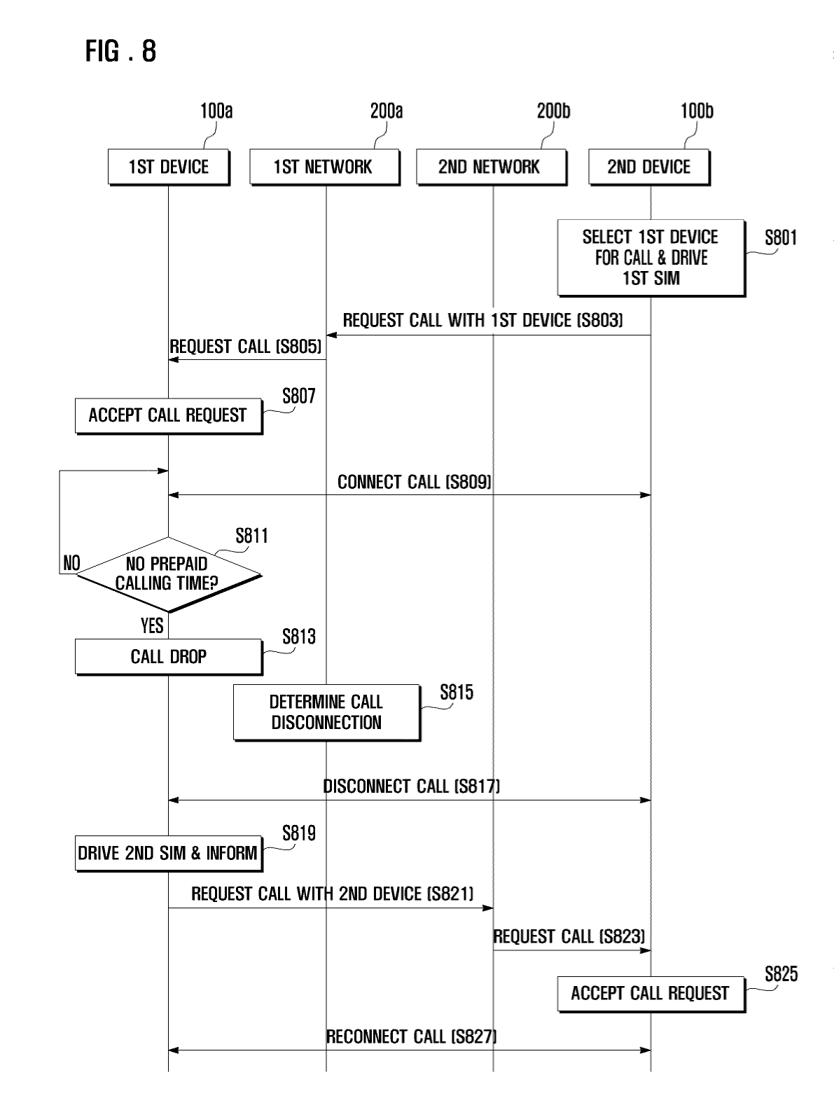

FIG. 8 is a flow diagram that illustrates a communication method between dual standby mobile devices and communication networks according to an exemplary embodiment of the present invention. The communication method in FIG. 8 is similar to the above described communication method in FIG. 7. However, the communication method of FIG. 8 determines a reason for a call disconnection.

Referring to FIG. 8, the second mobile device 100b selects the first mobile device 100a as a destination device for a call and drives the first SIM 109a as the master SIM in step S801.

The second mobile device 100b requests a call with the first mobile device 100a to a call control server of the first network 200a related to the first SIM 109a in step S803. The call control server of the first network transmits a call request of the second mobile device 100b to the first mobile device 100a in step S805.

After receiving the call request, the first mobile device 100a accepts the call request in step S807. Therefore, a call is connected between the first mobile device 100a and the second mobile device 100b in step S809.

The first mobile device 100a determines whether the remainder of the prepaid calling time in the first SIM 109a has been exhausted in step S811. If the first SIM 109a does not have any remaining prepaid calling time, the first mobile device 100a determines that a call drop occurred in the first network 200a in step S813.

The call control server of the first network 200a then determines a call disconnection between the first mobile device 100a and the second mobile device 100b in step S815. Therefore, a call is disconnected between the first mobile device 100a and the second mobile device 100b in step S817.

The first mobile device 100a drives the second SIM 109b and informs a user regarding the changeover between the SIMs by means of a pop-up window, an alarm sound, a vibration, or a sign lamp in step S819.

Next, the first mobile device 100a requests a call with the second mobile device 100b to a call control server of the second network 200b related to the second SIM 109b in step S821. The call control server of the second network then transmits a call request of the first mobile device 100a to the second mobile device 100b in step S823.

After receiving the call request, the second mobile device 100b accepts the call request in step S825. Accordingly, a call is reconnected between the first mobile device 100a and the second mobile device 100b in step S827. Additionally, the first mobile device 100a returns to step S811 and verifies whether prepaid calling time in the second SIM 109b is exhausted during a call.

As described above, a dual standby mobile device and a communication method thereof according to exemplary embodiments of the present invention may automatically reconnect an interrupted call by using a slave SIM instead of a master SIM when a call is disconnected due to unexpected errors, such as a low power area entry or an exhaustion of remaining prepaid calling time in a SIM. Therefore, the convenience of using a mobile device in different communication networks may be improved.

While this invention has been particularly shown and described with reference to certain exemplary embodiment thereof, it will be understood by those skilled in the art that various changes in form and details may be made therein without departing from the spirit and scope of the invention as defined by the appended claims and their equivalents.

What is claimed is:

1. A communication method of a dual standby mobile device which allows access to at least two different communication networks, the method comprising:
performing a call with another mobile device by driving a first Subscriber Identify Module (SIM);
determining a reason for a call disconnection when the call is disconnected;
performing a changeover to a second SIM when an unexpected error is the reason for the call disconnection; and
reconnecting the call with the other mobile device by driving the second SIM.

2. The method of claim 1, further comprising accessing a first communication network of the at least two different communication networks through the first SIM.

3. The method of claim 2, further comprising accessing a second communication network of the at least two different communication networks through the second SIM.

4. The method of claim 1, wherein the performing of the call comprises transmitting a call request to the other mobile device and receiving a call request from the other mobile device.

5. The method of claim 4, wherein the determining of the reason for the call disconnection comprises one of a low power area entry, an exhaustion of remaining prepaid calling time in the first SIM and an end action input.

6. The method of claim 5, wherein the unexpected error comprises one of the low power area entry and the exhaustion of the remaining prepaid calling time in the first SIM.

7. The method of claim 5, further comprising activating an alarm function to inform that the changeover to the second SIM is performed.

8. The method of claim 7, wherein the alarm function comprises one of a display of a pop-up window, an output of an alarm sound, a generation of a vibration and a turn-on of a sign lamp.

9. The method of claim 1, wherein the different communication networks comprises one of networks with different mobile standards and networks with different mobile operators.

10. The method of claim 9, wherein the different mobile standards comprises at least one of a Code Division Multiple Access (CDMA), a Global System for Mobile communication (GSM), a Wideband Code Division Multiple Access (WCDMA) and a Wireless Broadband (WiBro).

11. A dual standby mobile device comprising:
a first Subscriber Identify Module (SIM) and a second SIM for allowing access to at least two different communication networks;
a first communication unit for accessing a first communication network of the at least two types of communication networks through the first SIM driven to perform a call with another mobile device;
a second communication unit for accessing a second communication network of the at least two types of communication networks through the second SIM driven to perform the call with the other mobile device; and
a control unit for determining a reason for a call disconnection when the call is disconnected, for performing a changeover to the second SIM when an unexpected error is the reason for the call disconnection, and for reconnecting the call with the other mobile device by driving the second SIM.

12. The device of claim 11, wherein the control unit comprises:
a first controller and a second controller for controlling the different communication networks; and
an intermediate controller for interacting between the first controller and the second controller.

13. The device of claim 11, wherein the first SIM performs the call with the other mobile after one of transmitting a call request to the opposite mobile device and after receiving a call request from the opposite mobile device.

14. The device of claim 13, wherein the reason for the call disconnection comprises a low power area entry, an exhaustion of remaining prepaid calling time in the first SIM and an end action input.

15. The device of claim 14, wherein the unexpected error comprises one of the low power area entry and the exhaustion of the remaining prepaid calling time in the first SIM.

16. The device of claim 14, wherein the control unit activates an alarm function to inform that the changeover to the second SIM is performed.

17. The device of claim 16, wherein the alarm function comprises one of a display of a pop-up window, an output of an alarm sound, a generation of a vibration and a turn-on of a sign lamp.

18. The device of claim 11, wherein the different types of communication networks comprises one of networks with different mobile standards and networks with different mobile operators.

19. The device of claim 18, wherein the different mobile standards comprises at least one of a Code Division Multiple Access (CDMA), a Global System for Mobile communication (GSM), a Wideband Code Division Multiple Access (WCDMA) and a Wireless Broadband (WiBro).
